(19) United States
(12) Patent Application Publication
(10) Pub. No.: US 2006/0214772 A1
(43) Pub. Date: Sep. 28, 2006

(54) Anti-Collision Scheme for Active and Passive RFID Tag System

(75) Inventors: PingFu Hsieh, Tainan (TW); ChihChe Cheng, Tainan (TW); JuiLi Sun, Kaohsiung (TW)

Correspondence Address: BEEDAR TECHNOLOGY INC., R206, #12, NAN-KE 2ND ROAD,, TAINAN SCIENCE-BASED INDUSTRIAL PARK, TAINAN, TW

(73) Assignee: BEEDAR TECHNOLOGY INC., Tainan (TW)

(21) Appl. No.: 10/907,215

(22) Filed: Mar. 24, 2005

(51) Int. Cl. H04Q 5/22

(52) U.S. Cl. 340/10.2; 340/10.51

(57) ABSTRACT

Nowadays, RFID (radio frequency identification) products such as tags and readers become more and more popular. Therefore, the frequency band which they are operated in would get very crowded. Data fighting or collision among RFID products becomes an important issue. The invention is proposed to avoid data collision by using software program and hardware control in the RFID system.

### FIELD OF THE INVENTION

The invention relates to radio frequency identification (RFID) systems and wireless communication systems. Since data is transmitted and received in the air, every wireless communication channel has a defined capacity for data transferring which depends on the maximum data rate of this communication channel and the time span of its availability. All the communication systems could utilize this invention to improve the quality of data transferring.

### BACKGROUND OF THE INVENTION

In the recent years, radio frequency identification (RFID) has become very popular in many services, purchasing, distribution logistics, industry, manufacturing companies and material flow systems. It helps getting the information conveniently and quickly. However, for example, the collision could occur when numerous tags attempt to transfer data to the reader simultaneously. This results in communication failures. Therefore, the invention is proposed to solve this problem in the applications of RFID and wireless systems and make data collection, processing, and management handy to improve our life.

### SUMMARY OF THE INVENTION

According to the invention, users can enable anti-collision, select the modes, and set the associated duration by programming the configuration of memory. There are timing mode of fixed or flexible duration, mark mode, and bit-by-bit mode for selection. Moreover, the combinations of the three modes also enhance the anti-collision feature. Simultaneously, it will be better if the features of capacitance of the energy storage capacitors due to process variation, distance between tags and readers, or others are added.

### BRIEF DESCRIPTION OF THE DRAWINGS

FIG. 1 illustrates the RFID tag building block.

FIG. 2 illustrates the processing flowchart.

FIG. 3 illustrates the memory anti-collision setting assignment

FIG. 4 illustrates the anti-collision explanation.

FIG. 5 illustrates the anti-collision scheme of timing mode.

FIG. 6 illustrates the anti-collision scheme of mark mode.

FIG. 7 illustrates the anti-collision scheme of bit-by-bit search mode.

FIG. 8 illustrates an example for programmable anti-collision duration settings.

FIG. 9 illustrates the simulation results about transient condition of Vdd, based on 1 M ohm impedance and 50 pico farad capacitance.

### DETAILED DESCRIPTION OF A PREFERRED EMBODIMENT

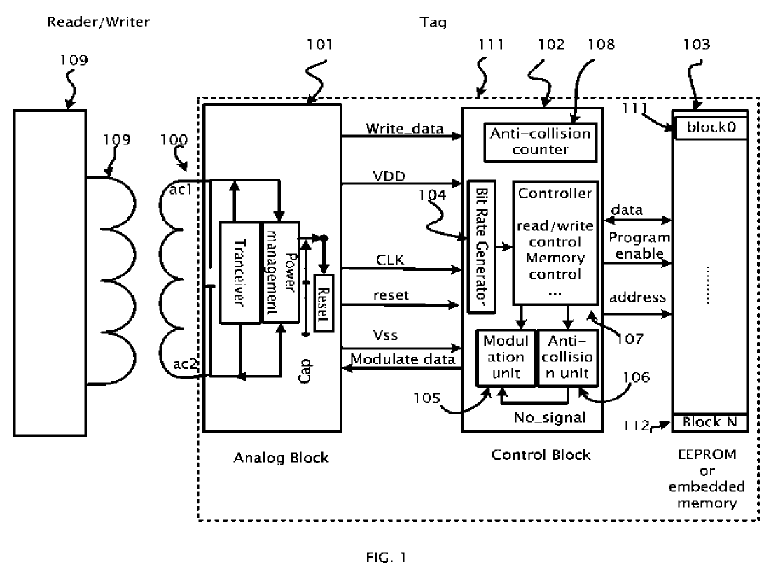

FIG. 1, the reader 109 always transfers the power to the tags 111 which start data communication with readers after getting sufficient energy.

When the reader 109 delivers the power via antenna 110 to the tag 111, at the same time, tag 111 receives the RF power via antenna 100, and passes it into the analog block 101. The block of power management in analog block 101 supplies stable power to control block 102 and embedded memory or EEPROM 103. The block of transceiver in analog block 101 is functioned to processes the receiving and transmitting analog signal coupled from wireless interface. Thus, digital control block 102 is able to execute coding/decoding, data integrity, function control algorithms, encryption mechanism . . . and so on. Before the system is initialized, the capacitor (CAP) behind power management block is charged from empty condition to certain level in some period of time. This depends on the CAP capacitance and the output impedance of power management. After the control block 102 receives the sufficient power from analog circuit 101 to be initialized, this block starts doing the following tasks:

Generate the bit rate clock which reader can be acceptable via bit rate generator 104.

Perform the read or write feature into memory 103 via controller 107.

Send the data out via modulation unit 105 into analog block 101 from the controller 107.

Perform the anti-collision feature if the anti-collision feature has been set via anti-collision unit 106, the control block 102 will enable the memory 103 to do the write task when the digital receives the write command from analog block 101.

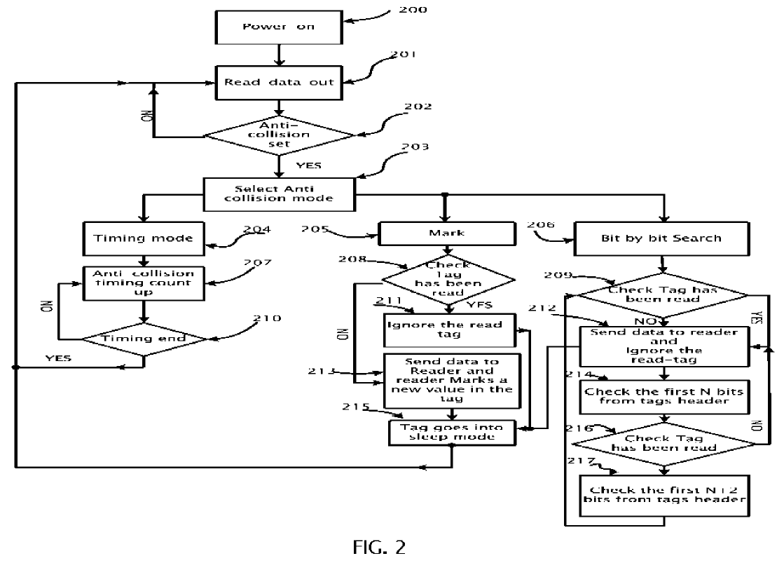

FIG. 2 is the anti-collision working flow chart, and sequence is the following:
When the control block 102 receives the power, the control block 102 will be powered up 200. If there is no write command translated in via analog block 101, control block 102 start reading the data from the block O 111 to block N 112 in embedded memory.
The anti-collision enable bit is set to enable this feature, and then one of three anti-collision modes got to be chosen in the anti-collision mode selection bit. The control block will perform the selected collision scheme. If timing mode 204 is selected, the anti-collision counter will start count up 207 until the timing end 210. The scheme then goes back to read data out 201. However, if the anti-collision counter 108 does not reach the anti-collision duration limits defined in the block N 207, the anti-collision counter will keep counting up to the maximum duration limits. If the mark mode 205 is selected, the tag will check the mark bit to see if this tag has been read or not 208. If this tag has been read, then this tag will go to sleep mode 215, and then stop sending the data to reader; otherwise the tag will sending the data to reader 213. At the same time, the reader will receive the data from tag, and mark a new value to tag. After reader receives the data, this tag will go into sleep mode 215. If the bit by bit search mode 206 is selected, the tag will check the mark bit, stop sending data to reader, and then go into sleep mode 215; Otherwise, the reader will check the first N bits in tag's header to see if this tag has been read or not 214. If not, the tag will transmit the data and update reader's database. After that, the tag will go into sleep mode 215, and stop sending any data to reader.

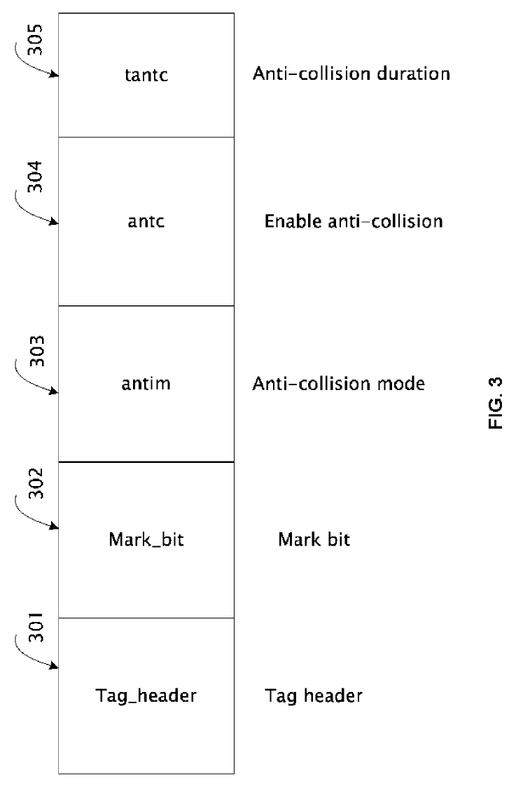

FIG. 3 shows the configuration memory mapping. As the above mention, the tag header bits 301 are used for readers in bit-by-bit search mode to check if this tag has been read or not. The mark bits 302 are used for readers in bit-by-bit search mode or mark mode to check if this tag has been read or not. The anti-collision mode bits 303 are employed to select one of three anti-collision modes to perform. The enable anti-collision bits are utilized to set the tag to enable the feature or not. The anti-collision duration bits are provided for timing mode to select various settings of duration. The longer the duration is, the stronger the feature is.

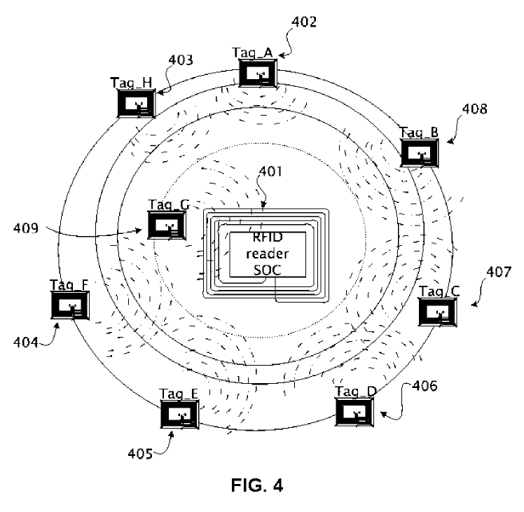

FIG. 4 shows the RFID communication system. The tags 402, 403, 404, 405, 406, 407, 408 and 409 receive the sufficient power from the reader 401, and start communication with the reader 401.

Because the data is transmitted and received in the air, the data always collides without anti-collision feature in the tags. Different distance to the reader for tags can also induce different voltage to charge the storage capacitors. The longer distance results in the longer anti-collision time; shorter distance does the shorter anti-collision time. Thus the induced voltage is able to implement another scheme of anti-collision.

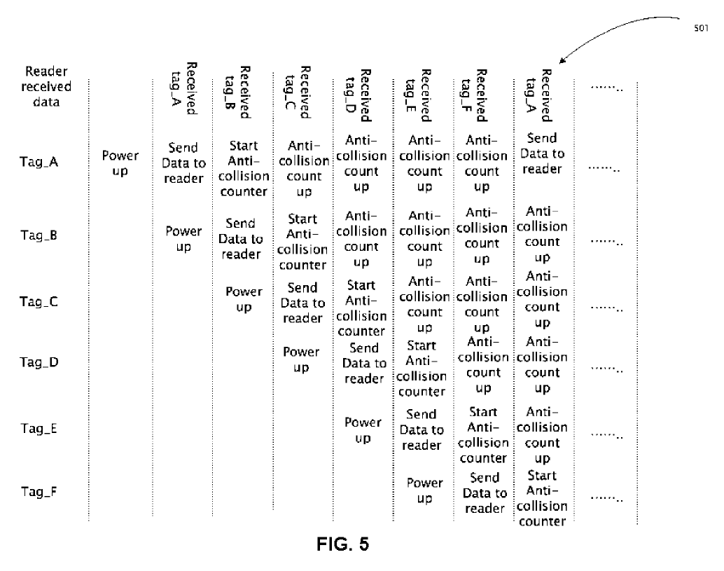

FIG. 5 illustrates the anti-collision scheme of timing mode. The control block is powered on after receiving sufficient power. If no write command is transferred via analog block, control block will start reading the data out from the block 0 to block N in embedded memory. If the anti-collision mode is set in timing mode, the anti-collision counter will start counting up until the time is ended. Then it is continuously read. However, if the anti-collision counter does not reach the anti-collision duration limits defined in the block N, the anti-collision counter will keep counting until the maximum duration limits. The successive tags are read out one by one as time goes.

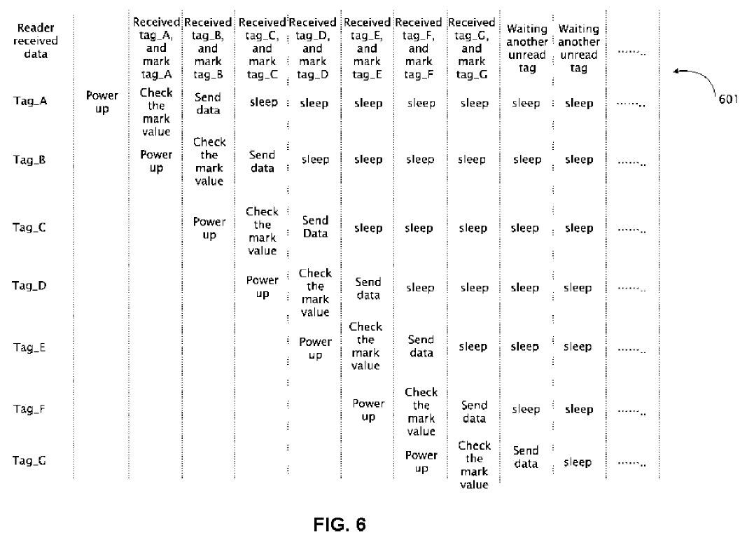

FIG. 6 illustrates the anti-collision scheme of mark mode. The control block is powered on after receiving sufficient power. If no write command is transferred via analog block, control block will start reading the data out from the block O to block N in embedded memory. If the mark mode is selected, the tag will check the mark bit to see if this tag has been read or not. If this tag has been read, then this tag will go to sleep mode, and then stop sending the data to reader; otherwise the tag will sending the data to reader. At the same time, the reader will receive the data from tag, and mark a new value to tag. After reader receives the data, this tag will go into sleep mode. Eventually, all of tags are read out after certain period of time.

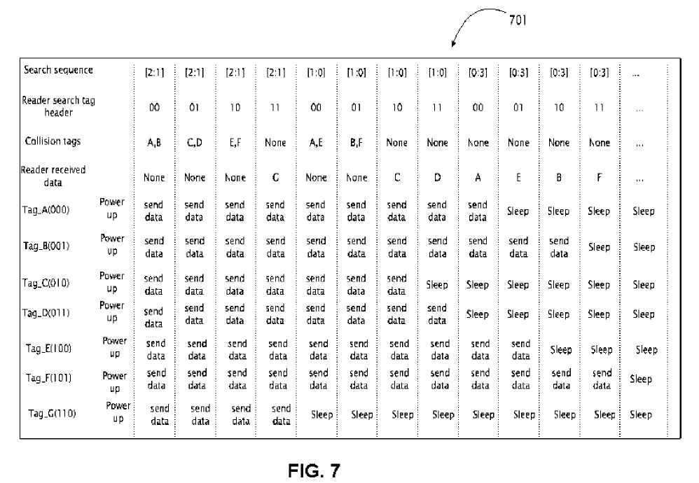

FIG. 7 shows the bit by bit search mode anti-collision method.
The control block is powered on after receiving sufficient power. If no write command is transferred via analog block, control block will start reading the data out from the block O to block N in embedded memory.

If the bit by bit search mode 206 is selected, the tag will check the mark bit, stop sending data to reader, and then go into sleep mode 215; Otherwise, the reader will check the first N bits in tag's header to see if this tag has been read or not 214. If not, the tag will transmit the data and update reader's database. After that, the tag will go into sleep mode 215, and stop sending any data to reader. The reader will search for the next few bits for the tag's header in next cycles when the data is collided in the previous cycle.

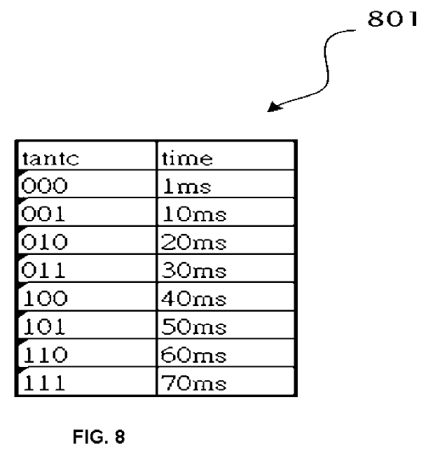

FIG. 8 shows the software program about anti-collision scheme of timing mode. The duration of anti-collision of timing mode is programmable in the memory by bit assignments. It depends on users' requirements.

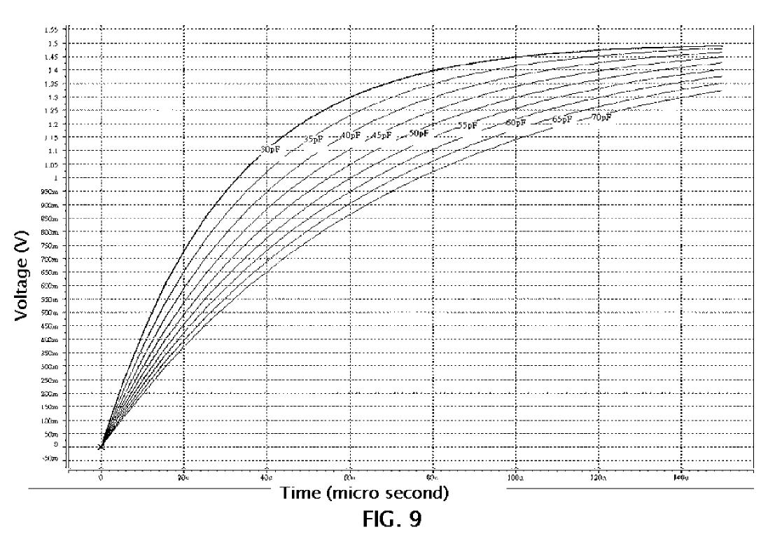

FIG. 9 shows the simulation results about various combinations of one mega ohm resistance and various capacitances of 30˜70 pico farad. It is obvious to observe that the ramp-up rate among them increases with decrease of CAP. The reset signal could be triggered to reset the control logic if VDD jumps over the designed threshold voltage of reset block. Therefore, the smaller capacitance the cap has, the earlier the systems are charged to wake up. The time interval could be enlarged as 10 us above, depicted in FIG. 9. Since the embedded capacitor may be manufactured with 30 percent tolerance due to process variation, typical value of 50 pico farad would varies from 35 pico farad to 65 pico farad. The process variation results to the different timing when the systems wake up. This advantage could enhance the feature of anti-collision with one of mechanisms mentioned above. By the way, it shows more powerfully especially for systems of higher operation frequency.

What is claimed is:

1. An arrangement of anti-collision methodology, comprising:
a control unit operable to transmit/receive data, run algorithm, and manipulate data flow.
a memory structure operable to store anti-collision information wherein includes program/erase and read function.
an anti-collision enable feature, wherein: turns on or off anti-collision feature according to the setting in memory.
an anti-collision timing mode feature, wherein: configures controllable timing-duration in memory.
an anti-collision mark bit feature, wherein: record mark information in memory. a tag head feature, wherein: record head information in memory.
an anti-collision bit-by-bit-search feature, wherein: record the related information in the head of memory.
a selectable anti-collision mode feature, wherein: configures selected anti-collision mode in memory. The mode may present only one anti-collision method. It also presents the combinations with many kinds of anti-collision method.

2. The methodology of anti-collision fix-timing mode according to claim 1 comprising steps:
send data.
enable anti-collision feature.
select anti-collision fix-timing mode.
enter sleep mode and sustain the setting anti-collision time.
continue procedure.

3. The methodology of anti-collision flex-timing mode according to claim 1 comprising steps:
send data.
Induce the voltage.
enable anti-collision feature.
select anti-collision flex-timing timing mode.
base on the different environment to select the anti-collision duration.
enter sleep mode and sustain the setting anti-collision time.
continue procedure.

4. The methodology of anti-collision mark mode according to claim 1 comprising steps:
send data.
enable anti-collision feature.
select anti-collision mark-mode.
feedback the mark value.
enter sleep mode and sustain the setting anti-collision time.

5. The methodology of anti-collision bit-by-bit-search mode according to claim 1 comprising steps:
send data.
enable anti-collision feature.
select anti-collision bit-by-bit-search mode.
check the tag's header.
decide to enter sleep mode to sustain the setting anti-collision time by check the tag's header.
continue procedure.

6. The method according to claim 1 wherein said due to process variation or others, different storage capacitances implement the anti-collision feature for all applicable frequency band.

7. The method according to claim 1 wherein said the different antenna material performs the anti-collision feature.

8. The method according to claim 1 wherein said the different distance between tags and reader implements the anti-collision feature.

9. The method according to claim 1 wherein said the anti-collision feature can be performed in the combinations of anti-collision mechanisms of fix-timing or flex-timing mode, mark mode, bit-by-bit-search-mode, various storage capacitors, antenna material, and different distance between tags and reader.
